(19) United States
(12) Patent Application Publication
(10) Pub. No.: US 2007/0272430 A1
(43) Pub. Date: Nov. 29, 2007

(54) ASYMMETRIC COMMUNICATION CABLE SHIELDING

(76) Inventors: Charles D. Tuffile, Dighton, MA (US); Michael Hardy, Cumberland, RI (US); Valerio Fokin, Attleboro, MA (US)

Correspondence Address: PEARNE & GORDON LLP, 1801 EAST 9TH STREET, SUITE 1200, CLEVELAND, OH, 44114-3108, US

(21) Appl. No.: 11/562,765

(22) Filed: Nov. 22, 2006

Related U.S. Application Data
(60) Provisional application No. 60/808,990, filed on May 26, 2006.

(51) Int. Cl. H01B 7/20; B32B 37/00

(52) U.S. Cl. 174/102 R; 156/250

(57) ABSTRACT

An asymmetric composite cable shield for use in communications cable that includes a protective layer clad with inner and outer layers of copper or a copper alloy, in which the inner layer is thicker than the outer layer.

### CONTINUING APPLICATION DATA

The present application claims priority from U.S. Provisional Application No. 60/808,990 filed May 26, 2006, the disclosure of which is hereby incorporated by reference herein.

### FIELD OF THE INVENTION

The invention relates to asymmetric communication cable shielding. More specifically, the invention relates to asymmetric copper clad cable shielding material for use in the telecommunications industry.

### BACKGROUND OF THE INVENTION

Many communication cable and wire products use a corrugated or helically wrapped metal strip as a shielding layer (hereinafter referred to as cable shielding, or shielding) that is wrapped around the conductor wires to provide a conductivity path for stray currents in the cable. Moreover, such shielding layers can also provide EMI/RFI protection from external electrical interference, and provide current-carrying capacity to ground currents induced by lightning strokes that reach the cable. Various materials, including steel, copper, and aluminum, have been used to provide cable shielding.

During electrical transmission, electromagnetic eddy currents tend to develop between the conductor wires and shielding. These electromagnetic eddy currents are detrimental to the electrical transmission because they act to attenuate the electrical signal strength as it is transmitted along the conductor wires. In order to address the detrimental impact of these electromagnetic eddy currents, the signal strength must be amplified along the transmission path to avoid its being attenuated to a level beyond which data could be lost. Minimizing the attenuation properties of the shield minimizes the cost of amplifying the signal by extending the distance between amplification points. The primary factors that affect the strength of eddy currents that develop between the conductor wires and shield in telecommunications cables are the transmission frequency, the magnetic permeability of the shield material, and the spacing between the conductor wires and the shield. A more detailed discussion of electromagnetic forces present in cable shielding can be found in U.S. Pat. No. 1,979,402, which is hereby incorporated by reference herein.

There are a variety of cable shielding materials known in the art. For example, Copper Development Association (CDA) 220 copper alloy strip, which consists of 90% Cu and 10% Zn, is a low-cost material that is used to provide shielding for non-rodent resistant buried service wire applications. The cost of this product is lower than many alternatives primarily due to its thinner gauge and lower copper content. The CDA 220 metal, which is used to provide a 0.0038″ thick cable shielding material, must be provided with a ½ hard temper to meet the strength requirements required for the strip to be used in communication cables. This temper results in significant spring back during forming, which makes corrugating and roll forming difficult.

Thicker materials are used, but generally result in a number of disadvantages. For instance, other materials used to prepare cable shielding are 0.0050| CDA 110, which is an electrolytic tough pitch commercially pure copper, and commercially pure aluminum (with a thickness of 0.0060″), both of which are used for non-rodent resistant buried service wire applications. However, the 5-mil and 6-mil thicknesses of these products results in significantly higher usage of material, making them is cost prohibitive when compared to the thinner 3.8-mil CDA 220 product. The greater shield thickness also affects the overall diameter of the cable, requiring more polyethylene to be provided to cover the communication cable.

Composite cable shielding materials have also been used to protect communication cables. Composite cable shielding generally includes one metal that provides structural strength, and another that provides improved corrosion resistance and desirable electrical properties. Typically, a steel portion of the strip provides intrinsic protective “armoring” properties that protect the cable's conductor wires (e.g., from rodent attack). However, since steel has a significantly higher magnetic permeability than many of the other shielding materials used for cable shielding, it creates the potential to develop strong, highly attenuating, eddy currents. The strength of the eddy currents is, in part, a function of the standoff distance between conductor wires and the steel in the shield. Hence, the steel layer in the shield should be spaced far enough away from the conductor wires in the cable to minimize the strength of the eddy currents that develop in order to reduce or diminish the occurrence of signal attenuation in the cable. The steel strip may thus be clad with another material such as copper or aluminum in order to provide the necessary standoff distance and high conductivity path for optimum cable performance. See for example U.S. Pat. No. 3,602,633, which is hereby incorporated by reference herein.

Current clad shielding designs use a symmetric stack up of layers such that the central “armoring” material (e.g., steel) is coated on each side by an equivalent amount of a cladding material such as copper or aluminum. In addition to reducing signal attenuation, the cladding material provides corrosion protection for the steel component of the shield. See for example U.S. Pat. No. 3,272,911, which is hereby incorporated by reference herein. Unfortunately, use of copper shielding material in communications cable is relatively expensive. It would be desirable to provide cost-effective communication cable shielding while minimizing the occurrence of signal attenuation.

### SUMMARY OF THE INVENTION

The present invention provides an asymmetrically clad cable shield in which the inner cladding layer has a greater thickness than the outer cladding layer. This asymmetrical design repositions cladding material to the inner side of the cable shield, improving electrical performance and allowing the total thickness to be reduced. As the design also minimizes the amount of cladding material required, it may also result in a substantial decrease in cost.

In one aspect, the invention provides a communication cable that includes a plurality of conductor wires forming a central core, an inner insulating layer surrounding the central core, a cable shield surrounding the inner insulating layer, and an outer insulating layer surrounding the cable shield. In this aspect, the cable shield includes a protective layer bonded between an inner and an outer copper or copper alloy cladding layer, wherein the inner cladding layer is thicker than the outer cladding layer. In one embodiment, the protective layer includes steel or a steel alloy. In a further embodiment, the cable shield is corrugated.

In an additional embodiment of the communication cable, the inner cladding layer is at least twice as thick as the outer cladding layer. In further embodiments, the inner cladding layer is at least four times, eight times, or twelve times as thick as the outer cladding layer. In yet another embodiment, the protective layer has a thickness of about 100% to about 300% of the combined thickness of the inner and outer cladding layers. In a further embodiment, the percentage thickness of the outer cladding layer is about 5-10%, the protective layer is about 45-65%, and the inner cladding layer is about 30-50%, wherein the percentage thickness of all three layers combined is 100%. In yet another embodiment, the cable shield has a thickness in the range from about 3 mil to about 5 mil.

In a further aspect, the invention provides an asymmetrical cable shield that includes: a protective layer bonded between an inner and an outer copper or copper alloy cladding layer, in which the inner cladding layer is thicker than the outer cladding layer. In one embodiment, the protective layer includes steel or a steel alloy. In further embodiments, the inner cladding layer is at least twice, four times, eight times, or twelve times as thick as the outer cladding layer. In further embodiments, the protective layer has a thickness of about 100% to about 300% of the combined thickness of the inner and outer cladding layers. In another embodiment, the percentage thickness of the outer cladding layer is about 5-10%, the protective layer is about 45-65%, and the inner cladding layer is about 30-50%, wherein the percentage thickness of all three layers combined is 100%. In yet further embodiments, the asymmetrical cable shield has a thickness in the range from about 3 mil to about 5 mil.

In yet another aspect, the invention provides a method of making an asymmetrical cable shield that includes the steps of: sandwiching a sheet of protective material between a sheet of copper or copper alloy outer cladding material and a sheet of copper or copper alloy inner cladding material; roll bonding the sheets of outer cladding material, protective material, and inner cladding material to provide a roll bonded material that includes a protective layer bonded between an inner and an outer copper or copper alloy cladding layer, wherein the inner cladding layer is thicker than the outer cladding layer; and cutting the roll bonded material to size to provide asymmetrical cable shielding.

In one embodiment, the method further includes the step of annealing the roll bonded material. In a further embodiment, the percentage thickness in the asymmetrical cable shielding of the outer cladding layer is about 5-10%, the protective layer is about 45-65%, and the inner cladding layer is about 30-50%, wherein the percentage thickness of all three layers combined is 100%. In another embodiment, the asymmetrical cable shielding has a thickness in the range from about 3 to about 5 mil, while in yet another embodiment the protective layer includes steel or a steel alloy.

### BRIEF DESCRIPTION OF THE FIGURES

FIG. 1 is a perspective view of an exemplary embodiment of a communication cable with corrugated cable shielding material.

FIG. 2 is an enlarged cross-sectional view of asymmetric cable shielding material taken on line 2-2 of FIG. 1.

FIG. 3 is a cross-sectional view along the axis of a communication cable that includes conductor wires encased in asymmetric cable shielding.

FIG. 4 is a cross sectional view perpendicular to the axis of a communication cable axis that includes conductor wires encased in asymmetric cable shielding.

The following detailed description is to be read with reference to the figures, in which like elements in different figures have like reference numerals. The figures, which are not necessarily to scale, depict selected embodiments and are not intended to limit the scope of the invention. Skilled artisans will recognize the embodiments provided herein have many useful alternatives that fall within the scope of the invention.

### DETAILED DESCRIPTION OF EMBODIMENTS OF THE INVENTION

The invention provides a cable shield for communications cable that includes a protective layer bonded between inner and outer copper or copper alloy cladding layers, in which the inner cladding layer is thicker than the outer cladding layer. By providing an inner cladding layer that is thicker than the outer cladding layer (i.e., an asymmetric clad design), more copper can be positioned in the area between the conductor wires and the shield in order to provide high conductivity as well as sufficient standoff distance to minimize signal attenuation. Use of an asymmetric clad design can also be used to provide cable shielding in which the overall amount of copper used can be decreased while maintaining the same, or greater, copper thickness in the area near the conductor wires to provide the desired electrical performance. Note that the terms cable shield and cable shielding have the same meaning and are used interchangeably herein.

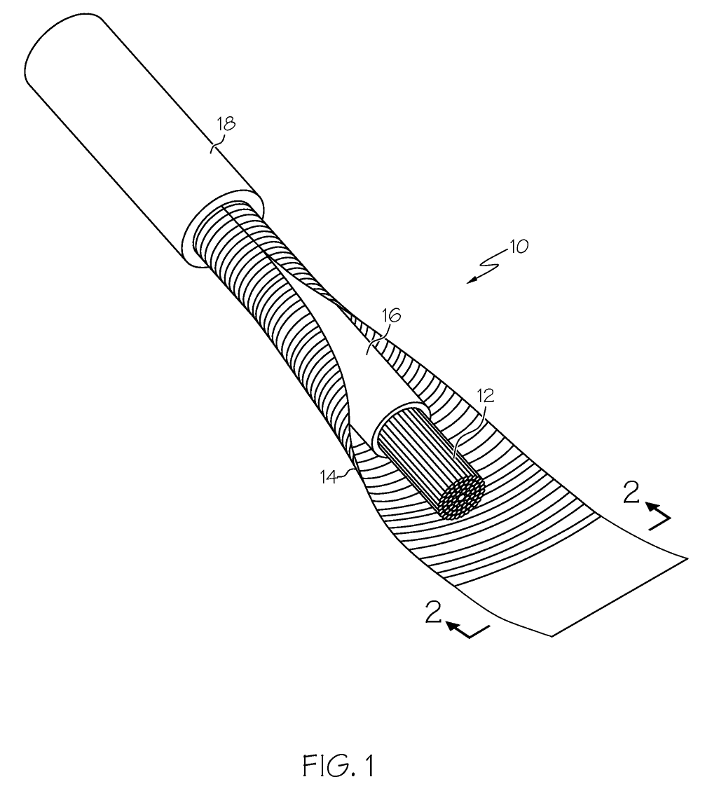

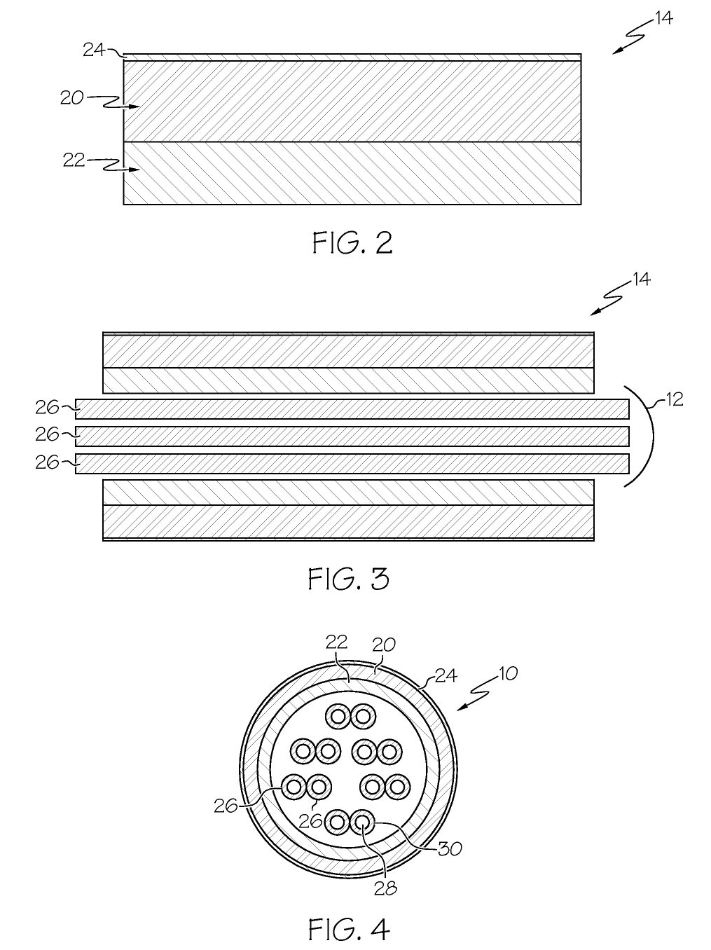

A perspective view of an exemplary embodiment of a communication cable with cable shielding of the invention is provided by FIG. 1. A communication cable 10 includes a central core 12 including a plurality of conductors. A sheath of cable shielding 14 surrounds the central core 12. FIG. 1 illustrates cable shielding 14 that has been corrugated to improve flexibility, but corrugation is not required. Between the cable shielding 14 and the central core 12 is a sheath of inner insulating layer 16. Finally, on the outside of the communication cable 10, surrounding the cable shielding 14, is a jacket of outer insulating layer 18. The inner insulating layer 16 and the outer insulating layer 18 are formed from flexible nonmetallic material such as a flexible polymer that forms a sheath or jacket around the central core 12 or the cable shield 14, respectively. For example, in one embodiment of the invention, low-density polyethylene is used to provide the inner insulating layer 16 while polyvinyl chloride is used to provide the outer insulating layer. The insulating layers serve to prevent undesired electrical leakage from and within the cable, and serve to protect other components of the communication cable 10. In FIGS. 2-4, the asymmetrical design of the cable shielding 14 is shown. As the metal layering within the cable shielding material cannot be seen in FIG. 1, FIGS. 2-4 are illustrating using a larger scale and without the presence of the insulating layers in order to clearly show the asymmetric nature of the cladding layers.

FIG. 2 provides a cross-sectional view of an embodiment of the asymmetric cable shielding 14 of the invention. FIG. 2 shows a central protective layer 20, an inner cladding layer 22, and an outer cladding layer 24. As can readily be seen in the figure, the inner cladding layer 22 has a thickness that is greater than the outer cladding layer 24. In FIG. 2, only a portion of the cable shielding 14 is shown, and in the figure the outer cladding layer 24 is shown as an upper layer, while the inner cladding layer 22 is shown as a lower layer. As noted above, the asymmetrical relationship between the cladding layers allows a greater portion of the cladding material to be located near the central core 12 to provide high conductivity and sufficient standoff distance from the conductor wires in the central core 12, while still providing a relatively thin layer of cladding material on the outer surface of the cable shielding 14. The relatively thin outer cladding layer 24 is sufficient to provide some corrosion protection, and also contributes to the electrical conductivity. This arrangement can be used to decrease the amount of cladding material needed to obtain a particular desired level of performance relative to cable shielding that is non-asymmetric. Decreasing the amount of cladding material needed can, for example, reduce the costs and/or improve the formability of the cable shielding 14 or communication cable 10 in which it is used.

To provide an asymmetric relation between the inner and outer cladding layers, the inner cladding layer should be thicker than the outer cladding layer. However, various embodiments of the invention may use specific ratios of the inner and outer cladding material to provide particular levels of performance and cost. For example, the inner cladding layer 22 may be twice as thick as the outer cladding layer 24. In further embodiments, the inner cladding layer 22 may be four times, eight times, or even twelve times as thick as the outer cladding layer 24. For example, for a 5-mil thickness cable shield, the outer cladding layer 24 could have a thickness of about 0.5-mil, the protective layer 20 a thickness of about 2.5-mil, and the inner cladding layer 22 a thickness of about 2-mils.

The inner cladding layer 22 and the outer cladding layer 24 are preferably composed of copper or a copper alloy. Preferably, the copper or copper alloy used has an international annealed copper standard (IACS) value of 90% or more. For example, pure annealed copper has an IACS value of 101%. Copper alloys may include various other metals in addition to copper, such as nickel, lead, tin, iron, silver, cadmium, tellurium, and zirconium. Typically the inner and outer cladding layers will be composed of the same copper or copper alloy. However, different copper or copper alloy materials can be used for the two cladding layers if desired. Examples of specific copper alloys that may be used include, for example, C10100, C10200, C10300, C10400, C10500, C10700, C10800, C10910, C11000, C11100, C11300, C11400, C11500, C11600, C12000, C12100, C12500, C12510, C12900, C14300, C14500, C14530, C14700, C15000, C15100, C15150, C15500, C15715, C16200, C18135, and C18700. See the Copper Development Association webpage maintained online for further details on various copper alloys and their compositions.

Between the inner and outer cladding layers is a protective layer 20. The protective layer includes a different material from that used in the cladding layers, thus providing a composite cable shielding material. Various amounts of material can be used to form the protective layer 20. The protective layer 20 should have sufficient thickness to provide the mechanical strength needed for the cable shielding 14, while not being so thick as to overly hinder formability. In some embodiments, the protective layer 20 should have sufficient strength to protect the cable from attack by rodents such as gophers. Accordingly, the protective layer 20 should be composed of a material that is strong, formable, and retains these characteristics when provided as a thin sheet. For example, the protective later 20 can be made of steel or a variety of steel alloys. A preferred steel for use in making the protective layer 20 is low carbon steel, which is relatively inexpensive. Examples of low carbon steel that may be used include 1006, 1008, and 1010 low carbon steel. Preferably, low carbon steel with a carbon content no greater than that provided by 1010 low carbon steel is used. Alternately, stainless steel or steel alloys may be used. Examples of steel alloys include steel alloyed with nickel, cobalt, titanium, aluminum, and copper.

While the thickness of the protective layer 20 may vary depending on the materials used, the protective layer 20 should have a thickness sufficient to provide the desired mechanical strength to the cable. Preferably, the thickness of the protective layer 20 is about equal to or greater than the thickness of the inner and outer cladding layers combined. For example, the thickness of the protective later 20 may vary from about 100% to about 300% of the thickness of the combined inner and outer cladding layers, with an intermediate value of about 200%.

The asymmetrical cable shielding 14 of the invention includes a protective layer sandwiched between two cladding layers. The three layers together preferably have a thickness ranging from about 3 to about 5 mils, and provide a material that has properties that are well suited for use as a cable shield. However, for applications where additional protection is desired (e.g., rodent protection), a thickness of about 5-10 mils may be used. The thickness of the various layers may vary as described above. For example, in one embodiment the percentage thickness of the outer cladding layer is about 5-10%, the protective layer is about 45-65%, and the inner cladding layer is about 30-50%, such that the percentage thickness of all three layers combined is 100%.

Preferably, the composite formed by combining the protective and cladding layers provides a material with a tensile strength in the range of 35-55 thousands of pounds per square inch (ksi), a yield strength in the range of 25-45 ksi, a percent elongation of 11% (minimum), and an electrical conductivity of 40% IACS (minimum). More preferably, the composite cable shielding 14 provides a tensile strength of about 44 ksi, a yield strength of about 38 ksi, a percent elongation of about 18%, and an electrical conductivity of about 53% IACS. An example of a asymmetrical cable shielding that provides these properties is cable shielding in which the ratio of thickness for the outer cladding, protective, and inner cladding layers is, respectively, 5/55/40, and further in which 1008 low carbon steel is used for the protective layer and commercially pure copper is used for the cladding layers.

The cladding and protective layers that make up the cable shielding 14 can be bonded to one another using techniques known to those skilled in the art. Briefly described, the process includes first obtaining sheets of material (e.g., coiled sheets) for use in making the protective layer and the cladding layers. The sheets of protective material and cladding material are prepared for roll bonding by chemical and/or mechanical cleaning. The cleaned protective material is then sandwiched between two or more layers of cleaned cladding material. The sandwiched sheets of material are then passed between a pair of bonding rolls in a conventional roll bonding mill. Preferably, lubrication is applied between the bonding rolls and the outer surfaces of the metal layers. The sandwiched package is rolled in one pass with sufficient force to reduce the package thickness by over approximately 40%, or preferably between approximately 50-70%, with the cladding material and the protective material reduced in thickness simultaneously in about the same proportion to provide cladding layers and a protective layer. A solid-state bond is thus created in the roll-bonded material at the interfaces between the protective layer and the cladding layers.

Optionally, the inner or outer layer of the roll bonded material can be identified by marking during the final rolling pass through the rolling mill. This can be done by creating a pattern on a work roll via processes such as etching, grit blasting, or machining. Because the “mark” has been rolled into the surface, it is durable enough to remain during additional finishing processing steps such as annealing and/or slitting without a significant degradation in visual appearance. Use of a mark on one side of the cable shielding material makes it easier to distinguish one side from the other in the asymmetric finished material.

The solid-state bond in the composite material may be further strengthened with an elevated temperature sintering and annealing cycle. The temperature of annealing should be controlled so as to not impart excessive inter-diffusion amongst the layers. Excessive diffusion can result in a degradation of the electrical properties the shield, resulting in, for example, a decrease in bulk electric conductivity. Further information on the preparation of solid-state bonded composite material may be found in U.S. Pat. No. 6,475,675, which is hereby incorporated herein by reference.

After bonding the layers, the roll-bonded material is then edge trimmed, if needed, to remove edge cracks and then continuously rolled to provide the desired finish gauge. The finish rolled material is then edge trimmed, if needed, and then cut to a size appropriate to provide cable shielding 14. Once formed, the asymmetric cable shield 14 can be used as is (i.e., without corrugation) to surround and protect the central core 12 of a communication cable 10. For example, in some applications where rigid or extra-heavy cable shielding is desired, it may be preferable to use cable shielding that has not been corrugated. However, for most applications the cable shield material is corrugated before being used to form a sheath around the central core 12. Corrugation involves altering the sheet of cable shield material such that it includes, for example, alternating ridges and grooves, and may be carried out using a conventional corrugation mill. An example of a corrugation pattern can be seen in FIG. 1, which shows a series of alternating ridges and grooves that run perpendicular to the axis of the central core to facilitate bending of the communication cable.

FIG. 3 is a cross-sectional view along the axis of a communication cable 10 that includes a central core 12 including conductor wires 26 encased in asymmetric cable shielding 14. The cable shielding wraps around the central core 12, as shown in both FIG. 1 and FIG. 4, generally with an inner insulating layer 16 placed in between. In one embodiment of the invention, the cable shield material is wrapped around the central core 12 such that one edge overlaps the other by a small amount (e.g., 0.075 inches or more) along the axis of the communication cable. In the alternative, particularly when the cable shield material is used without corrugation, the cable shield 14 may be applied helically around the central core 12 in a known manner (not shown), by using, for example, an assembly machine with a folding station. However, non-helical wrapping is generally preferred as this requires the use of less material to cover the central core 12.

As shown in FIGS. 1, 3, and 4, the central core 12 of the communication cable 10 includes a plurality of conductor wires 26. Inclusion of a plurality of conductor wires is what lends the device the name “cable.” Each of the conductor wires 26 include a conductor 28 surrounded by conductor insulator 30. The conductor 28 is a long wire of conductive material such as copper or aluminum. The conductor insulator 30 is preferably a flexible polymer, such as low-density polyethylene. The characteristics and manufacture of conductor wires 26 for use in communications cable 10 are well known to those skilled in the art.

Asymmetric cable shielding is a lower cost alternative to the other cable shielding designs, such as non-composite or composite symmetrical shielding, that are used to provide shielding in non-rodent resistant buried communication cable (e.g., telecommunication cable), primarily as a result of the significantly lower volume percentage of copper used. The protective layer of the asymmetric cable shielding also provides better forming characteristics for the cable shield of the invention relative to other cable shielding due to its low yield strength and high work hardening characteristics. While the asymmetric cable shielding described herein is ideal for use in non-rodent resistant buried communication cable, asymmetric cable shielding can also be used for a variety of other communication cable applications. For example, use of thicker shielding may provide the cable with rodent resistance, while still minimizing the cost of the materials being used relative to other shielding alternatives.

While various embodiments in accordance with the present invention have been shown and described, it is understood the invention is not limited thereto, and is susceptible to numerous changes and modifications as known to those skilled in the art. Therefore, this invention is not limited to the details shown and described herein, and includes all such changes and modifications as encompassed by the scope of the appended claims.

What is claimed is:

1. A communication cable comprising:
a plurality of conductor wires forming a central core;
an inner insulating layer surrounding the central core;
a cable shield surrounding the inner insulating layer;
and an outer insulating layer surrounding the cable shield, the cable shield comprising a protective layer bonded between an inner and an outer copper or copper alloy cladding layer, wherein the inner cladding layer is thicker than the outer cladding layer.

2. The communication cable of claim 1, wherein the protective layer comprises steel or a steel alloy.

3. The communication cable of claim 1, wherein the cable shield is corrugated.

4. The communication cable of claim 1, wherein the inner cladding layer is at least twice as thick as the outer cladding layer.

5. The communication cable of claim 1, wherein the inner cladding layer is at least four times as thick as the outer cladding layer.

6. The communication cable of claim 1, wherein the inner cladding layer is at least eight times as thick as the outer cladding layer.

7. The communication cable of claim 1, wherein the inner cladding layer is at least twelve times as thick as the outer cladding layer.

8. The communication cable of claim 1, wherein the protective layer has a thickness of about 100% to about 300% of the combined thickness of the inner and outer cladding layers.

9. The communication cable of claim 1, wherein the percentage thickness of the outer cladding layer is about 5-10%, the protective layer is about 45-65%, and the inner cladding layer is about 30-50%, wherein the percentage thickness of all three layers combined is 100%.

10. The communication cable of claim 1, wherein the cable shield has a thickness in the range from about 3 mil to about 5 mil.

11. An asymmetrical cable shield comprising:
a protective layer bonded between an inner and an outer copper or copper alloy cladding layer, wherein the inner cladding layer is thicker than the outer cladding layer.

12. The asymmetrical cable shield of claim 11, wherein the protective layer comprises steel or a steel alloy.

13. The asymmetrical cable shield of claim 11, wherein the inner cladding layer is at least twice as thick as the outer cladding layer.

14. The asymmetrical cable shield of claim 11, wherein the inner cladding layer is at least four times as thick as the outer cladding layer.

15. The asymmetrical cable shield of claim 11, wherein the inner cladding layer is at least eight times as thick as the outer cladding layer.

16. The asymmetrical cable shield of claim 11, wherein the inner cladding layer is at least twelve times as thick as the outer cladding layer.

17. The asymmetrical cable shield of claim 11, wherein the protective layer has a thickness of about 100% to about 300% of the combined thickness of the inner and outer cladding layers.

18. The asymmetrical cable shield of claim 11, wherein the percentage thickness of the outer cladding layer is about 5-10%, the protective layer is about 45-65%, and the inner cladding layer is about 30-50%, wherein the percentage thickness of all three layers combined is 100%.

19. The asymmetrical cable shield of claim 11, wherein the asymmetrical cable shield has a thickness in the range from about 3 mil to about 5 mil.

20. A method of making an asymmetrical cable shield, the method comprising the steps of:
sandwiching a sheet of protective material between a sheet of copper or copper alloy outer cladding material and a sheet of copper or copper alloy inner cladding material;
roll bonding the sheets of outer cladding material, protective material, and inner cladding material to provide a roll bonded material comprising a protective layer bonded between an inner and an outer copper or copper alloy cladding layer, wherein the inner cladding layer is thicker than the outer cladding layer; and
cutting the roll bonded material to size to provide asymmetrical cable shielding.

21. The method of claim 20, further including the step of annealing the roll bonded material.

22. The method of claim 20, wherein the percentage thickness in the asymmetrical cable shielding of the outer cladding layer is about 5-10%, the protective layer is about 45-65%, and the inner cladding layer is about 30-50%, wherein the percentage thickness of all three layers combined is 100%.

23. The method of claim 20, wherein the asymmetrical cable shielding has a thickness in the range from about 3 to about 5 mil.

24. The method of claim 20, wherein the protective layer comprises steel or a steel alloy.
